(19) United States
(12) Patent Application Publication
(10) Pub. No.: US 2017/0313604 A1
(43) Pub. Date: Nov. 2, 2017

(54) Wastewater Treatment Method

(71) Applicant: PeroxyChem LLC, Philadelphia, PA (US)

(72) Inventors: Alberto GARIBI, Haddonfield, NJ (US); Kati BELL, Brentwood, TN (US); Philip BLOCK, Garnet Valley, PA (US)

(73) Assignee: PeroxyChem LLC, Philadelphia, PA (US)

(21) Appl. No.: 15/581,670

(22) Filed: Apr. 28, 2017

Related U.S. Application Data
(60) Provisional application No. 62/329,573, filed on Apr. 29, 2016.

(51) Int. Cl. C02F 1/50; C02F 1/00; C02F 103/00

(52) U.S. Cl. CPC C02F 1/50; C02F 1/008; C02F 2209/08; C02F 2209/001; C02F 2103/001; C02F 2303/04; C02F 2209/005

(57) ABSTRACT

Provided herein are methods of reducing microbial concentrations in water with a peracid disinfectant. The method can include the steps of measuring the quality of the water in real-time and dosing the water with a first dose of a peracid disinfectant; measuring the peracid disinfectant demand; and adding one or more subsequent doses of the peracid disinfectant. The subsequent peracid disinfectant dose can be controlled by a processor-based controller based on peracid disinfectant demand.

### FIELD OF THE INVENTION

The present invention relates to the control of peracetic acid (PAA) for water and wastewater disinfection through a process utilizing feed-forward control on one or more incoming water or wastewater quality parameters in order to optimize disinfection performance and product use rates.

### BACKGROUND OF THE INVENTION

The treatment of water and wastewater, including household sewage and runoff, typically involved a multistep process to reduce physical, chemical and biological contaminants to acceptable limits, before such water or wastewater can be safely returned to the environment. Among the steps typically employed in a water treatment facility is a disinfection step, in which the water or wastewater is treated to reduce the number of microorganisms present.

This disinfection step may be achieved by a number of different methods, including by treatment with chlorine or chlorinated compounds, ozone and ultra violet light. The use of peracids in general and peracetic acid in particular, to disinfect water has also been proposed. U.S. Pat. No. 5,7367,057 (Minotti) discloses the use of peracids to purify water for human consumption. WO 2009/130397 (Talasma et al.) disclosed the addition of peracetic acid prior to sedimentation and after filtration to purify household water. U.S. Pat. Appl 2005/0164965 (Baum et al.) proposes the use of peracetic acid (PAA) to disinfect water in wet and dry weather water disinfection systems.

Control of water and wastewater disinfection by a variety of feed-back control mechanisms, including flow pacing and residual control has been described. (G. C. White, “Handbook of Chlorination and Alternative Disinfectants”, John Wiley and Sons, 1999). WO 2012/028778 (Kekko et al) discloses the use of feed-back control incorporating flow pacing with oxidation-reduction potential (ORP) downstream of the PAA introduction. Such feed-back control systems work well for waters and wastewaters without high disinfectant demand or when the disinfectant residual is relatively constant. However, for PAA, there is an instantaneous oxidant demand, typically about 10% or so, which reduces the initial PAA concentration. Unlike chlorine (whether present in the effluent as hypochlorite ion or hypochlorous acid), which remains in the effluent maintaining a residual concentration after disinfection, PAA undergoes auto-decomposition due to hydrolysis and additional interaction with non-target species. The reactivity of PAA can make standard flow pacing, with or without residual feed-back control, impractical or ineffective, especially in situations where there is high PAA demand or long contact times. As a result, the dosage of PAA may be suboptimal both in terms of efficacy and the increased amount of product required for antimicrobial activity.

### SUMMARY OF THE INVENTION

Provided herein are methods of reducing microbial concentrations in water with a peracid disinfectant. The method can include the steps of measuring the quality of the water with one or more real-time analytical devices; and dosing the water with a first dose of a peracid disinfectant; measuring the peracid disinfectant demand; and adding one or more subsequent doses of the peracid disinfectant, wherein the subsequent peracid disinfectant dose is controlled by a processor-based controller based on peracid disinfectant demand. The present invention relates to a method for treating water and wastewater by adding a peracid to such water or wastewater that has undergone primary or secondary treatment, characterized in that the water or wastewater is characterized prior to the addition of the peracid for one or more quality parameters, such as chemical oxygen demand (COD), total oxygen demand (TOD), color, % UV transmittance (UVT), oxidation/reduction potential (ORP) and others, in a continuous manner, and the peracid dosing is determined by correlation to one or more of these incoming water or wastewater parameters, via a feed-forward control algorithm, coupled with one or more feed-back control schemes, such as flow pacing or residual control. It has been unexpectedly found that for waters or wastewaters with high disinfectant demand or variable water quality, the disinfectant chemical usage and cost can be optimized with the continuous measurement of incoming water or wastewater quality, correlated to the PAA demand, and used for controlling the PAA dose rate.

### BRIEF DESCRIPTION OF THE DRAWINGS

These and other features and advantages of the present invention will be more fully disclosed in, or rendered obvious by, the following detailed description of the preferred embodiment of the invention, which is to be considered together with the accompanying drawings wherein like numbers refer to like parts and further wherein:

FIG. 1 is a graph showing PAA dose as a function of wastewater color and chemical oxygen demand (COD).

FIG. 2 is a graph showing Escherichia coli (E. coli) concentration in influent (diamonds) and effluent (squares) over an 11 week testing period.

FIG. 3 is a schematic illustrating one embodiment of the water treatment system.

### DETAILED DESCRIPTION OF THE PREFERRED EMBODIMENT

This description of preferred embodiments is intended to be read in connection with the accompanying drawings, which are to be considered part of the entire written description of this invention. The drawing figures are not necessarily to scale and certain features of the invention may be shown exaggerated in scale or in somewhat schematic form in the interest of clarity and conciseness. In the description, relative terms such as “horizontal,” “vertical,” “up,” “down,” “top” and “bottom” as well as derivatives thereof (e.g., “horizontally,” “downwardly,” “upwardly,” etc.) should be construed to refer to the orientation as then described or as shown in the drawing figure under discussion. These relative terms are for convenience of description and normally are not intended to require a particular orientation. Terms including “inwardly” versus “outwardly,” “longitudinal” versus “lateral” and the like are to be interpreted relative to one another or relative to an axis of elongation, or an axis or center of rotation, as appropriate. Terms concerning attachments, coupling and the like, such as “connected” and “interconnected,” refer to a relationship wherein structures are secured or attached to one another either directly or indirectly through intervening structures, as well as both movable or rigid attachments or relationships, unless expressly described otherwise. The term “operatively connected” is such an attachment, coupling or connection that allows the pertinent structures to operate as intended by virtue of that relationship. When only a single machine is illustrated, the term “machine” shall also be taken to include any collection of machines that individually or jointly execute a set (or multiple sets) of instructions to perform any one or more of the methodologies discussed herein. In the claims, means-plus-function clauses, if used, are intended to cover the structures described, suggested, or rendered obvious by the written description or drawings for performing the recited function, including not only structural equivalents but also equivalent structures.

The treatment of water and wastewater so that it can be safely returned to the environment typically involves a number of processes to remove physical, chemical and biological contaminants. Although specific treatment plants may use varying processes, in general, in the case of sewage effluent, it is first mechanically screened and the flow regulated to remove large objects such as sticks, packaging cans, glass, sand, stones and the like which could possibly damage or clog the treatment plant if permitted to enter. The screened wastewater is then typically sent through a series of settling tanks, where sludge settles to the bottom, while grease and oils rise to the surface. After the sludge is removed and the surface materials skimmed off, the wastewater is typically treated with microorganisms to degrade organic contaminants which are present. This biological treatment ultimately produces a floc, which is typically removed by filtration, either through sand or activated carbon. In the final stages of treatment, the microorganism content of the filtered water is reduced by disinfecting means, often by adding a disinfectant to the wastewater stream and having the mixture pass through a disinfectant contact chamber, wherein the disinfectant is maintained in contact with the wastewater for a sufficient period of time to reduce the microorganism level to the desired extent.

In most water treatment plants, chlorine or chlorinated compounds are employed as the disinfectant. Ozone and ultraviolet light treatments are also used. The use of peracids has been proposed, but their use has yet to become widespread due to the low relative cost of bleach and a lack of regulatory drivers regarding disinfection byproducts (DBPs) such as trihalomethanes and other chlorinated organics. The addition of the disinfectant is often controlled by a feed-back method, typically based on the flow rate of the water or wastewater (flow pacing) or a target residual of the disinfectant at some point, typically at the outfall of the contact chamber, through some type of continuous metering.

The feed-back control methods are usually sufficient for disinfectants such as chlorine, where the level of decomposition of the disinfectant is relatively low relative to the contact time in the chamber, or when the incoming water or wastewater quality does not have an impact on disinfectant residual. However, in the case of a peracid, such as peracetic acid (PAA), the peracid may undergo auto-decomposition, resulting in a continued decay of the peracid in the contact chamber. As a result, if the contact time is sufficient, changes in water or wastewater flow rate may impact the PAA residual in such a manner that the time the feed-back controller would take to adjust the PAA dose may result in an under-dosing of the PAA, leading to a reduced efficacy of microbial kill. Compensation for the reduced PAA levels may require an over-dosing of PAA to insure the target microbial levels are reach by the end of the contact chamber, resulting in a waste of chemical and its associated impact on final effluent water quality and disinfection costs. In addition, PAA undergoes an instantaneous loss due to reaction with organics and reduced metals in the water or wastewater. The reaction with organics and reduced metals typically results in a reduction of about ten percent of the initial PAA dosage. Changes in incoming water or wastewater quality may greatly impact the instantaneous PAA demand, reducing the overall PAA concentration and efficacy throughout the contact chamber. Feed-back routines would not be able to account for this instantaneous demand quickly enough to insure adequate microbial kill, and would result again in the need to over-feed the PAA to insure compliance to a specific microbial reduction.

Provided herein are methods of reducing microbial concentrations in water with a peracid disinfectant. The method can include the steps of measuring the quality of the water with one or more real-time analytical devices; and dosing the water with a first dose of a peracid disinfectant; measuring the peracid disinfectant demand; and adding one or more subsequent doses of the peracid disinfectant, wherein the subsequent peracid disinfectant dose is controlled by a processor-based controller based on peracid disinfectant demand. The water can be water that is contaminated with or at risk for microbial contamination, for example, drinking water, industrial and municipal wastewater, combined sewer overflow, rain water, flood water, and storm runoff water. In some embodiments, the water comprises an aqueous fluid stream. The source of the aqueous fluid stream can be a wastewater treatment plant.

The water quality can be measured by determining chemical oxidant demand (COD), total oxygen demand (TOD), biological oxidant demand (BOD), oxidation-reduction potential (ORP), color, percent ultraviolet light transmittance (% UVT), pH, turbidity, total suspended solids (TSS) or bacterial count. In some embodiments, the water quality is measured in real time.

The peracid disinfectant demand can be determined by measuring the quality of the water with one or more real-time devices. As noted, the quality of the water can be measured by determining chemical oxidant demand (COD), total oxygen demand (TOD), biological oxidant demand (BOD), oxidation-reduction potential (ORP), color, percent ultraviolet light transmittance (% UVT), pH, turbidity, total suspended solids (TSS) or bacterial count. In some embodiments, the peracid disinfectant demand is further determined by measuring the residual peracid in the water following dosing with the peracid.

The water quality and the peracid disinfectant demand are typically measured multiple times to allow sensitive and controlled dosing of the peracid disinfectant. In some embodiments, the water quality can be measured 2, 3, 4, 5, 6, 7, 8, 9, 10, 15, 20, 25, 30, 35, 40, 50, 60, 70, 80, 90, 100, 200, 300, 400, or 500 or more times. In some embodiments, the peracid disinfectant demand can be measured 2, 3, 4, 5, 6, 7, 8, 9, 10, 15, 20, 25, 30, 35, 40, 50, 60, 70, 80, 90, 100, 200, 300, 400, or 500 or more times. In some embodiments, the dosing step can be repeated multiple times, for example, 2, 3, 4, 5, 6, 7, 8, 9, 10, 15, 20, 25, 30, 35, 40, 50, 60, 70, 80, 90, 100, 200, 300, 400, or 500 or more times.

When the water comprises an aqueous fluid stream, both for measuring and the dosing steps can be carried out at multiple locations in the aqueous fluid stream. In some embodiments, measuring and the dosing step can be carried out at 2, 3, 4, 5, 6, 7, 8, 9, 10, 15, 20, or more locations in the aqueous fluid stream.

In some embodiments, additional parameters can be measured for example, the flow rate of the aqueous fluid stream or the pH of the water.

Accordingly, this invention incorporates the use of continuous water quality monitors to measure the changes in the incoming water or wastewater flow prior to peracid addition, correlating one or more water quality parameters, such as chemical oxygen demand (COD), total oxygen demand (TOD), color, % UV transmittance (UVT), oxidation/reduction potential (ORP) and others, to the instantaneous PAA demand with the use of a feed-forward control algorithm. The feed-forward control based on the continuously monitoring of water or wastewater quality may be coupled with feed-back control processes, such as flow pacing and residual control. The method of this invention is useful for a wide variety of wastewater treatment applications including surface discharge, re-use, combined sewer overflow and wet weather events, due to rain water or flood water, and drinking water.

Water quality parameters, such as chemical oxidant demand (COD), total oxidant demand (TOD), biological oxidant demand (BOD), water color, percent UV transmittance (% UVT), oxidation-reduction potential (ORP) and others are measured in real-time. A controller for optimization and control of the PAA dose can implement one or more of the algorithms disclosed herein. The correlation between water quality and PAA demand and efficacy can be determined and a feed-forward control algorithm can be established. The optimal PAA dose to achieve the target microbial reduction, while reducing minimizing product usage, can then be achieved via the feed-back control. In addition, flow pacing and/or feed-back algorithms utilizing PAA residual may be incorporated into the overall control scheme.

Useful peracids for the method of the present invention are peracetic acid (peroxyacetic acid or PAA) or performic acid, or a combination of the two. Peracetic acid is typically employed in the form of an aqueous equilibrium mixture of acetic acid, hydrogen peroxide, peracetic acid and water. The weight ratios of these compounds may vary greatly depending upon the particular grade of PAA employed. Among the grades of PAA which may be employed are those having the typical weight ratios of PAA:hydrogen peroxide:acetic acid from 12-18:21-24: 5-20; 15:10:36, 35:10:15 and 20-23:5-10:30-45.

Other organic peracids (also called peroxyacids) suitable for use in the method of this invention include one or more C₁ to C₁₂ peroxycarboxylic acids selected from the group consisting of monocarboxylic peracids and dicarboxylic peracids, used either individually or in combinations of two, three or more peracids. The peroxycaboxylic acid can be a C₂ to C₅ peroxycarboxylic acid selected form the group consisting of moncarboxylic peracids and dicarboxylic peracids. The peracid should be at least partially water-soluble or water-miscible.

One suitable category of organic peracids includes peracids of a lower organic aliphatic monocarboxylic acid having 1-5 carbon atoms, such as formic acid, acetic acid ethanoic acid), propionic acid propanoic acid), butyric acid (butanoic acid), iso-butyric acid (2-methyl-propanoic acid), valeric acid (pentanoic acid), 2-methyl-butanoic acid, iso-valeric acid (3-methyl-butanoic) and 2,2-dimethyl-propanoic acid. Organic aliphatic peracids having 2 or 3 carbon atoms, e.g., peracetic acid and peroxypropanoic acid, are highly suitable.

Another category of suitable lower organic peracids includes peracids of a dicarboxylic acid having 2-5 carbon atoms, such as oxalic acid (ethanedioic acid), malonic acid (propanedioic acid), succinic acid (butanedioic acid), maleic acid (cis-butenedioic acid) and glutaric acid (pentanedioic acid).

Peracids having between 6-12 carbon atoms that may be used in the method of this invention include peracids of monocarboxylic aliphatic acids such as caproic acid (hexanoic acid), enanthic acid (heptanoic acid), caprylic acid (octanoic acid), pelargonic acid (nonanoic acid), capric acid (decanoic acid) and lauric acid (dodecanoic acid), as well as peracids of monocarboxylic and dicarboxylic aromatic acids such as benzoic acid, salicylic acid and phthalic acid (benzene-1,2-dicarboxylic acid).

The peracid is added in concentrations sufficient to achieve the desired degree of treatment. The optimum concentrations will depend upon a number of factors, including the degree and types of microorganisms present; the degree of disinfection or treatment desired; the time in which the wastewater treated remains in the contact chamber; other materials present in the wastewater, and the like.

In general, when the peracid employed is PAA, the total amount of PAA him added should be sufficient to ensure that a concentration of between 0.5 and 50 parts per million by weight (“ppm”) of PAA, for example, of between 1 and 30 ppm of PAA, is present in the wastewater to be treated.

In the practice of the present invention, continuous or near-continuous measurement, that is, repeated measurements with a minimal interval between the measurements, of one or more water or wastewater quality parameter(s) is performed via insertion of an analytical probe or via continuous sampling instrumentation prior to the addition point of the peracid. Such water quality parameters may include, but is not limited to COD, TOD, color, % UVT, ORP, microbial concentration, pH, turbidity and total suspended solids (TSS). The signal from one or more of these analytical instruments is fed to a programmable logic computer (PLC).

In the initial phase of the PAA disinfection process, a series of tests is performed to establish the relationship of the water quality to PAA decomposition, residual and microbial reduction performance. The quality parameters that best model the PAA usage rate, typically determined by the best fitted correlation coefficient, are then coded within the PLC for feed-forward control purposes, typically in the form, but not limited to:

$$Δ PAA dose rate = {\sum }_{i = 1}^{j} {A}_{i} {x}_{i}^{m}$$

Where
xᵢ is water quality parameter i
Aᵢ is the functional pre-multiplier for water quality parameter i
m is the exponent (ex: 1, 2, etc) for water quality parameter i.

The PAA dose rate then is controlled to a specific set point with additional PAA being added as a function of incoming water quality. The typical set point for PAA ranges from 0.5-25 mg/L. This method allows for more precise control of fluctuating water conditions than feed-back only dose control, and results in a more efficient use of chemical to achieve the desired microbial reduction.

This feed-forward control based on in-coming water quality can be coupled with flow control and residual control to take into account fluctuations not only in water quality, but also water flow rate and resulting changes in contact time.

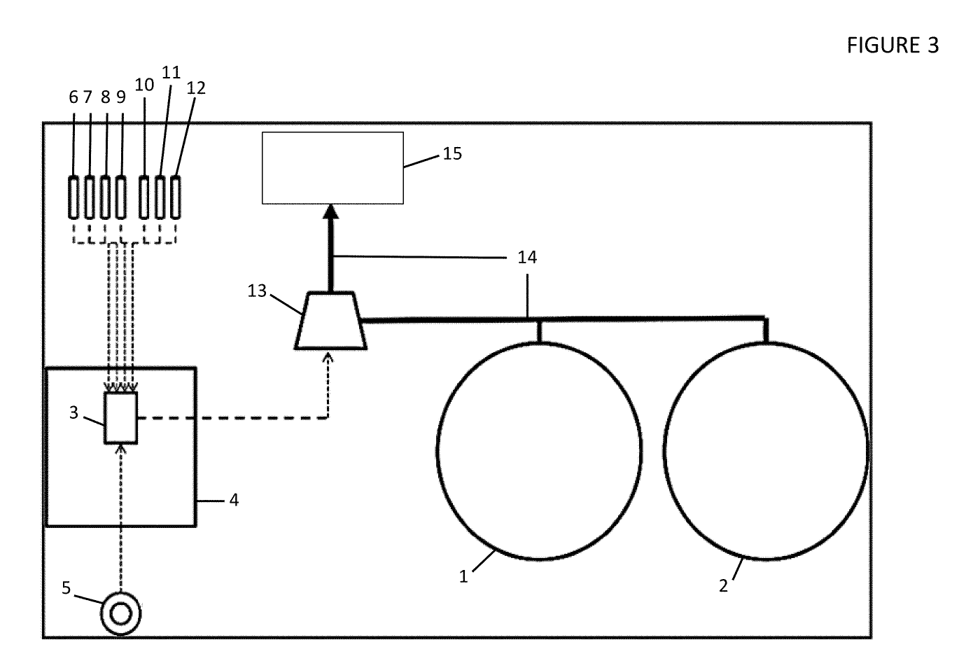

An exemplary system for carrying out the method of the claims is shown in FIG. 3. The system provides one or more high density polyethylene storage tanks 1 and 2 for storage of PAA. A processor-based controller, for example, a programmable logic controller (PLC) 3 housed in a control house 4 integrates signals from a wastewater flow meter 5 for flow pace control and inputs from one or more water quality probes 6, 7, 8, and 9 and one or more PAA monitoring probes 10, 11, and 12 for dose control. The water quality probes can measure for example, color 6, COD 7, UVT 8, and ORP 9. Based on the signals from the wastewater flow meter 5 and the inputs from the water quality probes 6, 7, 8, and 9 and the PAA monitoring probes 10, 11, and 12, the PLC 3 signals a PAA delivery pump 13 to direct the delivery of PAA from the storage tanks via PAA delivery pipe 14 to a disinfection channel in the disinfection contact chamber 15.

### EXAMPLES

A full scale trial of peracetic acid (15% PAA:23% hydrogen peroxide) disinfection was performed at a wastewater treatment plant in Tennessee, USA. The wastewater contained a high level of colored, aromatic molecules discharged from industrial sources involved in the processing of cotton seeds and other sources of lignin and bio-based polymers. The water quality, and as a result the peracetic acid (PAA) demand, was heavily dependent upon the cyclic discharge rates from these industrial sources. Thus, the PAA efficacy in reducing bacterial concentrations within the wastewater was not only dependent upon the overall flow rate of the WWTP, but also upon the time-dependent water quality. The time-dependent water quality demand on PAA at the treatment plant required the inclusion of a PAA feed-forward dosing scheme to insure that the proper dosing of PAA needed to achieve the target microbial reduction was maintained.

Initial testing consisted of collecting continuous, on-line data for four wastewater quality parameters: color, chemical oxygen demand (COD), oxidation/reduction potential (ORP) and UV transmittance (UVT) at 254 nm. Peracetic acid was measured in situ via the Prominent Dulcotest CTE sensor. The sensor was a membrane-capped amperometric, two electrode sensor for the measurement of PAA in aqueous solution. The sensor had a platinum working electrode and a silver halogenide coated counter or reference electrode. PAA contained in the sample water diffused through the membrane, causing a potential difference between electrodes. The primary signal was converted by the amplifier electronics of the sensor into a 4-20 mA, temperature corrected, output signal, which was optimally controlled via the DULCOMETER diaLog DACa controller. Wastewater color was measured on-line utilizing a ChemScan UV-3151 Series Analyzer with a flow-through sensor. The analyzer drew a sample of wastewater from the untreated side of the disinfection channel, representative of the influent wastewater, to the main unit, which was located in the control house. Wastewater COD and % UVT (% ultraviolet transmittance at 254 nm) were measured on-line using a submersible YSI CarboVis model 701 unit. E. coli analysis were performed by a third-party laboratory, using the IDEXX Colisure method.

The data for each quality parameter then was correlated to PAA demand, accounting for wastewater flow rate. E. coli concentrations were measured at the inflow to the disinfection channel, at the mid-point of the disinfection channel and at the outflow.

During this initial testing, PAA was dosed in flow-paced mode only. The selection of the wastewater parameters used to design the PAA feed-forward dosing algorithms was based on two criteria: the lowest least-squares (r²) fit and the greatest degree of sensitivity between changes in the wastewater parameter and the PAA demand. As a result of the initial testing, wastewater color (r²=0.70) and wastewater COD (r²=0.66) were chosen as the feed-forward control parameters for additional testing. A feed-forward dose pacing algorithm, coupled with wastewater flow pacing, was developed for each of these two wastewater quality parameters.

The PAA dose was determined by:

PAA_{dose}=PAAₛₑₜ+PAA_{demand}

where PAAₛₑₜ is determined during subsequent testing and PAA_{demand} is determined by the fit of the PAA residual versus water quality parameter from the initial testing. The dosing algorithm of PAA_{demand} was determined to be:

PAA_{demand}=2.01*color^{0.285}−10

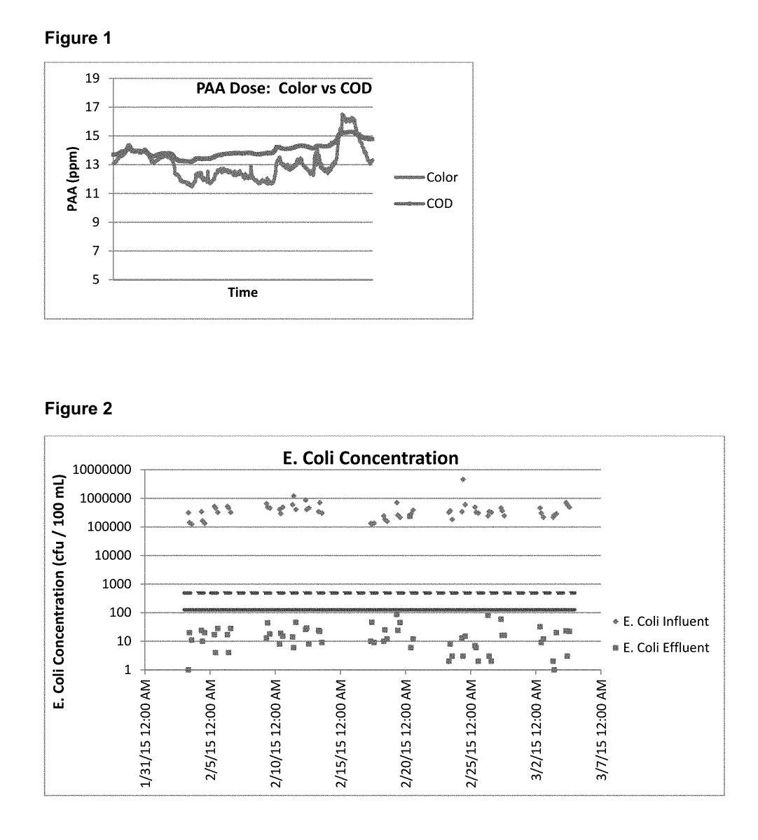

The impact on PAA dose as a function of wastewater color and COD is shown in FIG. 1. Subsequent testing was performed with wastewater color as the water quality parameter for feed-forward control of the PAA dose (PAA_{demand}), coupled with flow pacing. Analysis of the data from the field testing indicated that the PAAₛₑₜ point for this wastewater was 7 ppm to achieve the desired E. coli reduction at demand neutral performance.

At least three cycles of water quality (minimum to maximum wastewater color) were tested with flow rates ranging from 50 to 130 MGD. Sixty three E. coli concentrations were measured during this period. All but one concentration were below the permitted daily maximum of 487 cfu/100 mL (see FIG. 2). The one exception occurred during an extended power outage at the plant, during which time, no PAA was dosed to the disinfection chamber. If this one E. coli measurement is eliminated, then the E. coli arithmetic mean concentration for this testing was 18 cfu/100 mL and the geomean was 12 cfu/100 mL. The monthly geomean was well below the target permitted monthly maximum geomean of 126 cfu/100 mL. The E. coli log reduction ranged from 3.4 to 6.2.

These results suggested that with just flow pace control, and a dose set at 7 mg/L, the PAA initial concentration would have been significantly under-dosed and the target effluent microbial concentration would not have been met. If flow pace control were used, and the PAA dose was set to meet the wastewater PAA demand under all conditions, this would have required a PAA set dose at 17 mg/L, as compared to the average PAA dose of approximately 14 mg/L, resulting in the consumption of a significantly higher volume of PAA over the period. At the flow rates tested under (40-140 MGD), the contact times varied significantly. Under the lower flow rates, the contact time would be such that residual feed-back control only would result in too long a period to maintain the PAA dose required to reach the target microbial concentration at the outflow. The feed-forward method allowed for rapid PAA dose response, thereby minimizing chemical consumption and maximizing efficacy in a wastewater with high PAA demand and highly variable wastewater quality.

What is claimed is:

1. A method of reducing microbial concentrations in water with a peracid disinfectant, the method comprising
a) measuring the quality of the water with one or more real-time analytical devices; and
b) dosing the water with a first dose of a peracid disinfectant;
c) measuring the peracid disinfectant demand; and
d) adding one or more subsequent doses of the peracid disinfectant, wherein the subsequent peracid disinfectant dose is controlled by a processor-based controller based on peracid disinfectant demand.

2. The method of claim 1, wherein the water is selected from the group consisting of drinking water, industrial and municipal wastewater, combined sewer overflow, rain water, flood water, and storm runoff water.

3. The method of claim 1, wherein the water comprises an aqueous fluid stream.

4. The method of claim 3, wherein the source of aqueous fluid stream is a wastewater treatment plant.

5. The method of claim 1, wherein the peracid disinfectant is peracetic acid, performic acid or a combination thereof.

6. The method of claim 1, wherein the water quality is measured by determining chemical oxidant demand (COD), total oxygen demand (TOD), biological oxidant demand (BOD), oxidation-reduction potential (ORP), color, percent ultraviolet light transmittance (% UVT), pH, turbidity, total suspended solids (TSS) or bacterial count.

7. The method of claim 1, wherein the peracid disinfectant demand is determined by measuring the quality of the water with one or more real-time analytical devices.

8. The method of claim 7, wherein the water quality is measured by determining chemical oxidant demand (COD), total oxygen demand (TOD), biological oxidant demand (BOD), oxidation-reduction potential (ORP), color, percent ultraviolet light transmittance (% UVT), pH, turbidity, total suspended solids (TSS) or bacterial count.

9. The method of claim 7, where in the peracid disinfectant demand is further determined by measuring the residual peracid in the water following dosing with the peracid.

10. The method of claim 1, wherein steps (c) and (d) are repeated 2, 3, 4, 5, 6, 7, 8, 9, 10, 15, 20, 25, 30, 35, 40, 50, 60, 70, 80, 90, 100 or more times.

11. The method of claim 3, further comprising measuring the peracid disinfectant demand at multiple locations in the aqueous fluid stream.

12. The method of claim 3, further comprising adding the subsequent doses of the peracid disinfectant at multiple locations in the aqueous fluid stream.

13. The method of claim 3, further comprising measuring the flow rate of the aqueous fluid stream.

14. The method of claim 1, further comprising measuring the pH of the water.

15. A method of reducing microbial concentrations in water with a peracid disinfectant, the method comprising
a) measuring the quality of the incoming water by one or more real-time analytical devices; and
b) optimizing and controlling the peracid disinfectant dose via a processor-based controller based on the output of the one or more analytical devices, wherein the output is correlated with peracid disinfectant demand.

16. The method of claim 15, wherein the water is selected from the group consisting of drinking water, industrial and municipal wastewater, combined sewer overflow, rain water, flood water, and storm runoff water.

17. The method of claim 15, wherein the peracid is peracetic acid, performic acid or a combination thereof.

18. The method of claim 15, wherein the water quality is measured by determining chemical oxidant demand (COD), total oxygen demand (TOD), biological oxidant demand (BOD), oxidation-reduction potential (ORP), color, percent ultraviolet light transmittance (% UVT), pH, turbidity, total suspended solids (TSS) or bacterial count.

19. A method of reducing microbial concentrations in water with a peracid disinfectant, the method comprising
a) measuring the quality of the incoming water by one or more real-time analytical devices; and
b) optimizing and controlling the peracid disinfectant dose via a controller based on the output of one or more analytical devices, wherein the output is correlated with peracid disinfectant demand and residual.

20. The method of claim 19, wherein the water is selected from the group consisting of drinking water, industrial and municipal wastewater, combined sewer overflow, rain water, flood water, and storm runoff water.

21. The method of claim 19, wherein the peracid is peracetic acid, performic acid or a combination thereof.

22. The method of claim 19, wherein the water quality is measured by determining chemical oxidant demand (COD), total oxygen demand (TOD), biological oxidant demand (BOD), oxidation-reduction potential (ORP), color, percent ultraviolet light transmittance (% UVT), pH, turbidity, total suspended solids (TSS) or bacterial count.

23. The method of claim 19, further comprising optimizing and controlling the progressive disinfectant dose via one or more additional feedback controller.

24. The method of claim 19, wherein the feedback control is based on flow pacing, peracetic acid residual feedback control or a combination thereof.
